(19) United States
(12) Patent Application Publication
(10) Pub. No.: US 2017/0293150 A1
(43) Pub. Date: Oct. 12, 2017

(54) MAGNIFYING DEVICE FOR A MOBILE DEVICE

(71) Applicants: Ricky Montoya, Covina, CA (US); Amy Beth Franklin, Covina, CA (US)

(72) Inventors: Ricky Montoya, Covina, CA (US); Amy Beth Franklin, Covina, CA (US)

(21) Appl. No.: 15/485,136

(22) Filed: Apr. 11, 2017

Related U.S. Application Data
(60) Provisional application No. 62/320,866, filed on Apr. 11, 2016.

(51) Int. Cl. G02B 27/02; H04W 4/02; H04B 1/3888; G02B 1/14; G02B 25/00

(52) U.S. Cl. CPC G02B 27/027; G02B 1/14; G02B 25/005; H04B 1/3888; H04W 4/02

(57) ABSTRACT

A magnifying device for a mobile device is a case, for inserting a cellular phone into, that has a see-through front cover with a magnifying screen for enlarging the print on the screen of the cellular phone. A pocket on the back cover holds a thin magnifier for using to enlarge the minute print often used in cellular phone menus.

### CROSS-REFERENCE TO RELATED APPLICATION

The present application is related to and claims priority from prior provisional application Ser. No. 62/320,866, filed Apr. 11, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of magnifying devices and more specifically relates to magnifying device for a mobile device.

### 2. Description of the Related Art

One the most explosive new technologies to come out of the last thirty years is the cellular telephone. In 1994, 16 million Americans were subscribers to cellular phone services. By 2002, that number had ballooned to more than 110 million, and still shows no sign of slowing down. In fact, some experts predicted that worldwide subscribership would reach 1.2 billion people by the end of 2014. The basic concept of cellular phones began in 1947, when AT&T researchers sought ways to increase the traffic capacity and frequency of mobile communication in police car radios.

However, nonexistent technology and stringent FCC regulations postponed availability until 1982, when the FCC authorized commercial cellular use. As a result of this regulation, the scientific advances of the intervening years and increased competition among communications companies put the cellular telephone on the fast track. Today's widespread use of these revolutionary devices is unsurprising, since they now offer a virtually endless array of benefits. In addition to serving as a practical means of communication while on the go, technological advances have evolved cell phones into mini computers. Capable of keeping consumers abreast of the latest stock quotes, providing wireless Internet access, capturing photos and videos, enabling social networking, and playing music and games, in addition to many other features, cellular smartphones have become practically indispensable to millions the world over.

As technology changes on virtually a daily basis, cell phones are continuously evolving to incorporate new features to make these devices even more convenient for the consumer. Whether one wants a phone that can take pictures or allow for hands-free usage or both, there is certain to be a model readily available for that user. One effect that has resulted from advanced cellular technology is that the display screens on many models have only gotten smaller, as sleeker, space age phone designs have become all the rage. Unfortunately, this can prove quite a challenge for consumers who suffer from some form of vision impairment. Whether needing to see who is calling via caller ID, wanting to check e-mail through the phone, or desiring to respond to a text message, these users typically find themselves clamoring for their spectacles or even with corrective lenses, still straining to see the information on the screen. A convenient and practical solution is needed.

Various attempts have been made to solve the above-mentioned problems such as those found in U.S. Pub. No. 2013/0242416 to David Joseph Feola; U.S. Pat. No. 8,681,437 to Thomas A Jaffee; and U.S. Pat. No. 7,792,550 to Ruan Lishan. This art is representative of magnifying devices for mobile devices. None of the above inventions and patents, taken either singly or in combination, is seen to describe the invention as claimed.

Ideally, a magnifying device should provide ease of use and be attached to the mobile device, and yet, would operate reliably and be manufactured at a modest expense. Thus, a need exists for a reliable magnifying device for a mobile device for ease of use and to be attached to the mobile device to prevent misplacing, to avoid the above-mentioned problems.

### BRIEF SUMMARY OF THE INVENTION

In view of the foregoing disadvantages inherent in the known magnifying device art, the present invention provides a novel magnifying device for a mobile device. The general purpose of the present invention, which will be described subsequently in greater detail, is to provide ease of use and be attached to the mobile device to prevent misplacing.

The magnifying device for a mobile device preferably comprises an encasement including a front portion that includes an aperture therethrough, a back portion pivotally connected to the front portion, and the encasement is adapted to retain a mobile device between the front and back portions. A magnifying lens is removably attached to the front portion that covers the aperture such that the magnifying lens is adapted to magnify the surface of the mobile device when the mobile device is placed and retained between the front and back portions.

The magnifying lens is formed as an aspheric magnifying lens and is formed from a translucent material. The encasement is formed having a rectangular shape adapted to retain a mobile device that is also rectangularly shaped. The encasement is preferably formed from a plastic material. The magnifying lens is preferably formed having a protective coating formed from Cera-tec®. The magnifying lens preferably has a magnification power of between 4-times magnification and 6-times magnification.

The back portion further may include a pocket member for holding a menu magnifier member adapted to slide in and out of the pocket member. The encasement further may include a tracking computer chip embedded within and adapted to be used to determine the location of the magnifying device in the event of loss or theft. It may also include a remote tracking device adapted to communicate electronically and remotely with the tracking computer chip and is adapted to be attached to a key ring to be used to remotely to determine the location of the magnifying device.

The invention may be as a combination of a mobile device and a magnifying device for the mobile device and may comprise a mobile device with a main body that includes a screen member adapted to display information thereon, electronic components located within the main body that are adapted to communicate with remotely located electronic systems and display information on the screen member, a magnifying device comprising an encasement including a front portion having an aperture therethrough and a back portion pivotally connected to the front portion with the encasement adapted to retain the mobile device between the front and back portions, and a magnifying lens removably attached to the front portion that covers the aperture such that the magnifying lens is adapted to magnify the screen member of the mobile device when the mobile device is placed and retained between the front and back portions.

The magnifying lens is formed as an aspheric magnifying lens made from a translucent material. The mobile device and the encasement are formed having substantially similar rectangular shapes, such that the mobile device is adapted to fit within the encasement so that the screen member of the mobile device is able to be aligned with the magnifying lens of the encasement. The magnifying lens is formed having a protective coating and is formed having a magnification power of between 4-times magnification and 6-times magnification.

The back portion further includes a pocket member for holding a menu magnifier member adapted to slide in and out of the pocket member. The encasement further includes a tracking computer chip embedded within and adapted to be used to determine the location of the magnifying device. A remote tracking device is adapted to communicate electronically and remotely with the tracking computer chip such that it can be attached to a key ring and be used to remotely determine the location of the magnifying device.

The present invention holds significant improvements and serves as a magnifying device for a mobile device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, magnifying device for a mobile device, constructed and operative according to the teachings of the present invention.

FIG. 1 shows a perspective view illustrating a magnifying device for a mobile device according to an embodiment of the present invention.

FIG. 2 is a perspective view illustrating the magnifying device for a mobile device in an open position according to an embodiment of the present invention of FIG. 1.

FIG. 3 is a perspective view illustrating a menu magnifier member of the magnifying device for a mobile device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a magnifying device and more particularly to a magnifying device for a mobile device as used to improve the for ease of use and to be attached to the mobile device to prevent misplacing.

Generally speaking, a magnifying device for a mobile device is a case, for inserting a cellular phone into, that has a see-through front cover with a magnifying screen for enlarging the print on the screen of the cellular phone. A pocket on the back cover holds a thin magnifier for using to enlarge the minute print often used in cellular phone menus.

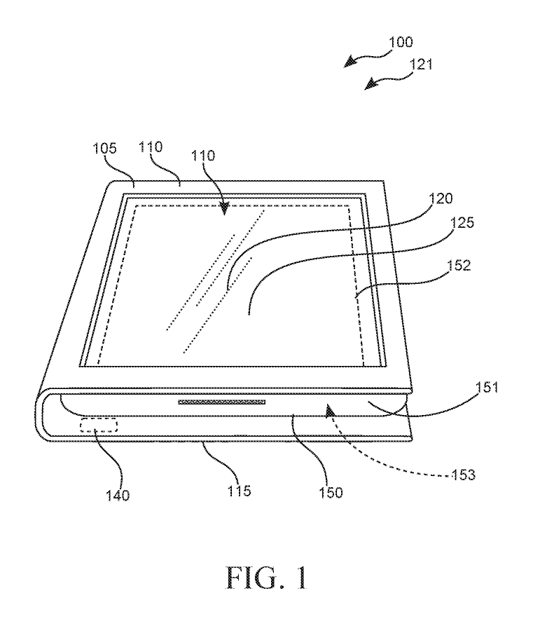

In greater detail now, referring to the drawings by numerals of reference there is shown in FIG. 1, a perspective view illustrating magnifying device for a mobile device 100 according to an embodiment of the present invention.

Magnifying device for a mobile device 100 preferably comprises encasement 105 including front portion 110 that includes aperture 111 therethrough, back portion 115 pivotally connected to front portion 110, and encasement 105 is adapted to retain mobile device 150 between front portion 110 and back portion 115. Magnifying lens 120 is removably attached to front portion 110 that covers aperture 111 such that magnifying lens 120 is adapted to magnify the surface of mobile device 150 when mobile device 150 is placed and retained between front portion 110 and back portion 115.

Magnifying lens 120 is formed as an aspheric magnifying lens 120 and is formed from a translucent material. Encasement 105 is formed having a rectangular shape adapted to retain mobile device 150 that is also rectangularly shaped. Encasement 105 is preferably formed from a plastic material. Magnifying lens 120 is preferably formed having protective coating 125 formed from cera-tec®. Magnifying lens 120 preferably has a magnification power of between 4-times magnification and 6-times magnification.

Back portion 115 further may include pocket member 130 for holding menu magnifier member 135 adapted to slide in and out of pocket member 130. Encasement 105 further may include tracking computer chip 140 embedded within and adapted to be used to determine the location of magnifying device 121 in the event of loss or theft. It may also include remote tracking device 145 adapted to communicate electronically and remotely with tracking computer chip 140 and is adapted to be attached to a key ring to be used to remotely to determine the location of magnifying lens 120.

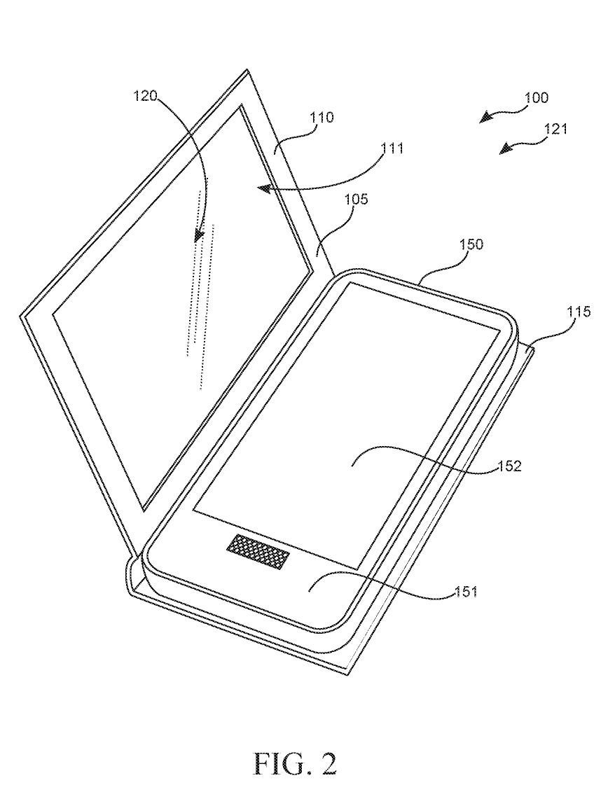

Referring now to FIG. 2, a perspective view illustrating magnifying device for a mobile device 100 in an open position according to an embodiment of the present invention of FIG. 1.

The invention 100 may be as a combination of mobile device 150 and magnifying lens 120 and may comprise mobile device 150 with main body 151 that includes screen member 152 adapted to display information thereon, electronic components 153 located within main body 151 that are adapted to communicate with remotely located electronic systems and display information on screen member 152, magnifying device 121 comprising encasement 105 including front portion 110 having aperture 111 therethrough and back portion 115 pivotally connected to front portion 110 with encasement 105 adapted to retain mobile device 150 between front portion 110 and back portion 115, and magnifying lens 120 removably attached to front portion 110 that covers aperture 111 such that magnifying lens 120 is adapted to magnify screen member 152 of mobile device 150 when mobile device 150 is placed and retained between front portion 110 and back portion 115.

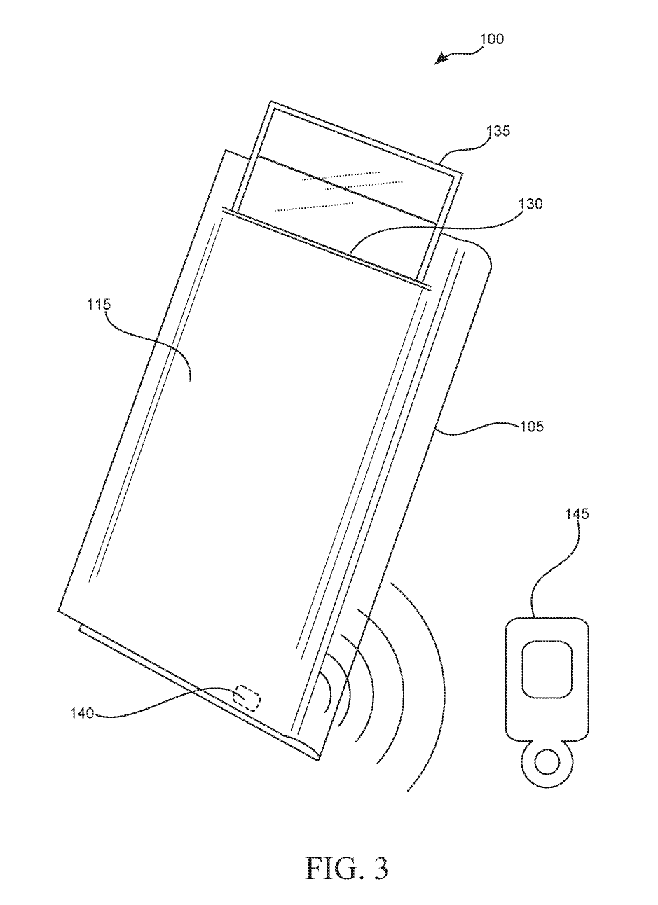

Referring now to FIG. 3, is a perspective view illustrating menu magnifier member 135 of magnifying device for a mobile device 100 according to an embodiment of the present invention of FIG. 1.

Magnifying lens 120 is formed as an aspheric magnifying lens 120 made from a translucent material. Mobile device 150 and encasement 105 are formed having substantially similar rectangular shapes, such that mobile device 150 is adapted to fit within encasement 105 so that screen member 152 of mobile device 150 is able to be aligned with magnifying lens 120 of encasement 105. Magnifying lens 120 is formed having protective coating 125 and is formed having a magnification power of between 4-times magnification and 6-times magnification.

Back portion 115 further includes pocket member 130 for holding menu magnifier member 135 adapted to slide in and out of pocket member 130. Encasement 105 further includes tracking computer chip 140 embedded within and adapted to be used to determine the location of magnifying device 121. Remote tracking device 145 is adapted to communicate electronically and remotely with tracking computer chip 140 such that it can be attached to a key ring and be used to remotely determine the location of magnifying device 121.

Magnifying device for a mobile device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., specific kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A magnifying device for a mobile device, comprising:
an encasement including:
a front portion;
wherein said front portion includes an aperture therethrough;
a back portion;
wherein said back portion is pivotally connected to said front portion;
wherein said encasement is adapted to retain a mobile device between said front and back portions;
a magnifying lens;
wherein said magnifying lens is removably attached to said
front portion and covers said aperture, such that said
magnifying lens is adapted to magnify a surface of said mobile
device when said mobile device is placed and retained between
said front and back portions.

2. The magnifying device of claim 1, wherein said magnifying lens is formed as a aspheric magnifying lens.

3. The magnifying device of claim 1, wherein said magnifying lens is formed from a translucent material.

4. The magnifying device of claim 1, wherein said encasement is formed having a rectangular shape adapted to retain a mobile device having a rectangular shape.

5. The magnifying device of claim 1, wherein said encasement is formed from a plastic material.

6. The magnifying device of claim 1, wherein said magnifying lens is formed having a protective coating thereon.

7. The magnifying device of claim 6, wherein said protective coating is formed from Cera-tec®.

8. The magnifying device of claim 1, wherein said magnifying lens is formed having a magnification between 4-times magnification and 6-times magnification.

9. The magnifying device of claim 1, wherein said back portion further includes a pocket member; and wherein said magnifying device further comprises a menu magnifier member adapted to slide in and out of said pocket member.

10. The magnifying device of claim 1, wherein said encasement further includes a tracking computer chip embedded therein and adapted to be used to determine the location of said magnifying device.

11. The magnifying device of claim 10, further comprising a remote tracking device adapted to communicate electronically and remotely with said tracking computer chip, such that said remote tracking device is adapted to be attached to a keyring and be used to remotely determine the location of said magnifying device.

12. A combination of a mobile device and a magnifying device for said mobile device, said combination comprising:
a mobile device comprising:
a main body including:
a screen member adapted to display information thereon;
electronic components;
wherein said electronic components are located within said main body and are adapted to communicate with remotely located electronic systems and display information on said screen member; and
a magnifying device comprising:
an encasement including:
a front portion;
wherein said front portion includes an aperture therethrough;
a back portion;
wherein said back portion is pivotally connected to said front portion;
wherein said encasement is adapted to retain said mobile device between said front and back portions;
a magnifying lens;
wherein said magnifying lens is removably attached to said front portion and covers said aperture, such that said magnifying lens is adapted to magnify said screen member of said mobile device when said mobile device is placed and retained between said front and back portions.

13. The magnifying device of claim 12, wherein said magnifying lens is formed as an aspheric magnifying lens.

14. The magnifying device of claim 13, wherein said magnifying lens is formed from a translucent material.

15. The magnifying device of claim 12, wherein said mobile device and said encasement are formed having substantially similar rectangular shapes, such that said mobile device is adapted to fit within said encasement and said screen member of said mobile device be aligned with said magnifying lens of said encasement.

16. The magnifying device of claim 12, wherein said magnifying lens is formed having a protective coating thereon.

17. The magnifying device of claim 12, wherein said magnifying lens is formed having a magnification between 4-times magnification and 6-times magnification.

18. The magnifying device of claim 12, wherein said back portion further includes a pocket member; and wherein said magnifying device further comprises a menu magnifier member adapted to slide in and out of said pocket member.

19. The magnifying device of claim 12, wherein said encasement further includes a tracking computer chip embedded therein and adapted to be used to determine the location of said magnifying device.

20. The magnifying device of claim 19, further comprising a remote tracking device adapted to communicate electronically and remotely with said tracking computer chip, such that said remote tracking device is adapted to be attached to a keyring and be used to remotely determine the location of said magnifying device.
